(19) United States
(12) Patent Application Publication
(10) Pub. No.: US 2015/0070868 A1
(43) Pub. Date: Mar. 12, 2015

(54) SHIELDING ELEMENT FOR USE IN MEDIUM VOLTAGE SWITCHGEARS, AND METHOD FOR MANUFACTURE THE SAME

(71) Applicant: ABB Technology AG, Zurich (CH)

(72) Inventors: Wenkai SHANG, Ratingen (DE); Dietmar GENTSCH, Ratingen (DE)

(73) Assignee: ABB Technology AG, Zurich (CH)

(21) Appl. No.: 14/543,281

(22) Filed: Nov. 17, 2014

Related U.S. Application Data
(63) Continuation of application No. PCT/EP2013/001413, filed on May 14, 2013.

(30) Foreign Application Priority Data
May 15, 2012 (EP) 12003826.0

(51) Int. Cl. H01H 33/662; H02B 13/025

(52) U.S. Cl. CPC H01H 33/66261; H02B 13/025; H01H 2033/66276
USPC 361/816; 29/428

(57) ABSTRACT

A shielding element is provided for medium voltage switchgears with vacuum interrupters having at least two contacts, which are movable along a switching path between closed and open contact positions. The shielding element is positioned around the contact position region in the vacuum interrupter. To reduce the use of material and to optimize the energy absorbance behavior of the shielding element, the inner surface of the shielding element is applied with a topographic structure which is aligned parallel to the switching path of the contacts. The present disclosure also provides a method of manufacturing such a shielding element.

### RELATED APPLICATIONS

This application claims priority as a continuation application under 35 U.S.C. §120 to PCT/EP2013/001413, which was filed as an International Application on May 14, 2013 designating the U.S., and which claims priority to European Application 12003826.0 filed in Europe on May 15, 2012. The entire contents of these applications are hereby incorporated by reference in their entireties.

### FIELD

The present disclosure relates to a shielding element for use in medium voltage switchgears with vacuum interrupters having at least two contacts, which are movable along a switching path between closed and open contact positions. The shielding element is positioned around the contact position region in the vacuum interrupter. The present disclosure also relates to a method of making such a shielding element.

### BACKGROUND INFORMATION

Vacuum interrupters can be equipped with inner shielding elements, surrounding the contact position in the closed and opened positions.

By using a profiled shielding for vacuum interrupters, it is possible to absorb more metal vapour for vacuum interrupters during switching, and thereby increase the interrupting capability, as disclosed in DE 19503347 A1.

In known configurations, if the profiled shielding is used, then the profile is tangential to the axis of shielding and needs to be made by machining, as disclosed in DE 19503347 A1. The profile is tangential to the shielding; therefore, the production method can only use machining, and the wall thickness for the shielding has to be thick, in order to have enough bulk material to get a profiled shielding after machining.

### SUMMARY

An exemplary embodiment of the present disclosure provides a shielding element for a medium voltage switchgear with at least one vacuum interrupter having at least two contacts. The contacts are movable along a switching path between closed and open contact positions. The shielding element is positioned around a region of the contact position in the vacuum interrupter. The shielding element includes an inner surface having a topographic structure which is aligned parallel to the switching path of the contacts.

An exemplary embodiment of the present disclosure provides a method for manufacturing a shielding element for a medium voltage switchgear with at least one vacuum interrupter having at least two contacts. The contacts are movable along a switching path between closed and open contact positions. The exemplary embodiment includes positioning the shielding element around a region of the contact position in the vacuum interrupter, and forming an inner surface of the shielding element to have a topographic structure which is aligned parallel to the switching path of the contacts. In addition, the exemplary method includes forming the shielding element from at least one segment, which are manufactured as contoured cylindrical elements, and applying the topographic structure by deep drawing in a direction along a cylinder-long-axis of the shielding element.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a perspective view of a shielding element according to an exemplary embodiment of the present disclosure;

FIG. 2 shows a cross-section of a groove of the shielding element according to an exemplary embodiment of the present disclosure;

FIG. 3 shows a cross-section of a groove of the shielding element according to an exemplary embodiment of the present disclosure;

FIG. 4 shows a cross-section of a groove of the shielding element according to an exemplary embodiment of the present disclosure; and

FIG. 5 shows a perspective view of the shielding element arranged in a vacuum interrupter, according to an exemplary embodiment of the present disclosure.

### DETAILED DESCRIPTION

Exemplary embodiments of the present disclosure, in comparison to known techniques, reduce the use of material in the construction of the shielding element, and at the same time, optimize the energy absorbance behavior of the shielding element.

In accordance with an exemplary embodiment, the inner surface of the shielding element has a topographic structure which is aligned parallel to the switching path of the contacts.

In accordance with an exemplary embodiment, the topographic structure of the inner surface of the shielding element is an alignment of parallel grooves. This arrangement causes an advantageous “folding” of the surface in the sense of an extension of the surface for absorption of energy.

In accordance with an exemplary embodiment, the cross section of the alignment of the grooves is in a Z-structure with sharp edges.

In accordance with an exemplary embodiment, the cross section of the alignment of the grooves is a wave-structure with round edges.

In accordance with an exemplary embodiment, the cross section of the alignment of the grooves is a U-structure with sharp edges.

All these topographic structures can be easily manufactured by deep drawing, because of the orientation of the structures.

According to an exemplary embodiment, in case of a sectionized shielding arrangement, at least the regions nearest to the contact positions can be structured in the above-described configurations.

In addition to the topographic structuring of the shielding element, each contact is mounted on a stem, and at least partial regions near to the contact piece can be additionally applied with topographic surface structures, in order to absorb energy from light arc occurrence.

In accordance with an exemplary embodiment, the backside of the electrodes, and/or the shielding plate, and/or the inner side of the end cover can be additionally applied with the above-described topography structure, in order to absorb the energy and vapor from arc.

An exemplary embodiment of the present disclosure provides a method for manufacturing such a shielding element. The method includes making the shielding to include at least one or more segments, which can be manufactured as contoured cylindrical elements as described above. The topographic structure is applied by deep drawing in the direction along the cylinder-long-axis of the shielding.

In the present disclosure, the profile is in the axial direction of shielding; therefore, the profile could be made by using deep drawing or protrusion during the production process, thin wall shielding could be also used; therefore with cost effective production for profiled shielding.

In accordance with the techniques of the present disclosure, the condensation surface of the metal vapor is increased, resulting in the following differences from known configurations: 1) the profile is in the axial direction to the shielding axis in parallel with the switching path axis, and 2) the production method by the present disclosure can utilize deep drawing and a protrusion process. This is contrary to known configurations, in which the profile can only be made by machining. Additional differences from known configurations include 3) by using this method the manufacture of shielding for “normal” vacuum interrupter without increase of costs for the vacuum interrupter and more secure for the performance of vacuum interrupters, and 4) this could be also for different materials, Cu, Cu/Cr, and Cu alloys.

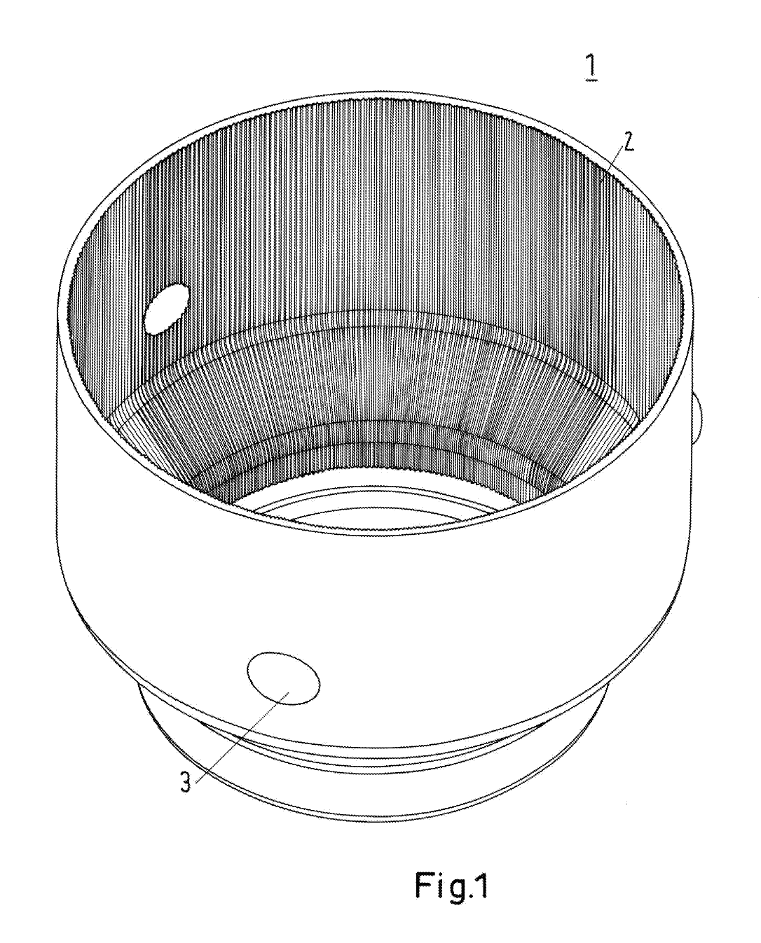

An example of the profile of the present disclosure is shown in FIG. 1. It is to be understood that other kinds of profiles as in above mentioned patent application could be also used, such as those which can be oriented in the same way, parallel to the switching path axis of the contacts, so that the profile can be introduced into the inner shielding surface by deep drawing

FIG. 1 shows a perspective view of a shielding element 1 according to an exemplary embodiment of the present disclosure. In the exemplary embodiment of FIG. 1, the shielding element 1 can have the form of a contoured cylinder. In contrast to known configurations, the topographic structure 2 of the shielding element 1 is implemented as parallel aligned grooves. The orientation of the topographic structure 2 (e.g., the grooves) is consequently parallel to the contact movement axis (i.e., parallel to the switching path of the contacts of the vacuum interrupter).

Furthermore, as shown in FIG. 1, the shielding element 1 may contain dimples 3, in order to facilitate positioning the shielding element 1, including particular sections of the shielding element 1 based on the dimples 3, inside the vacuum interrupter.

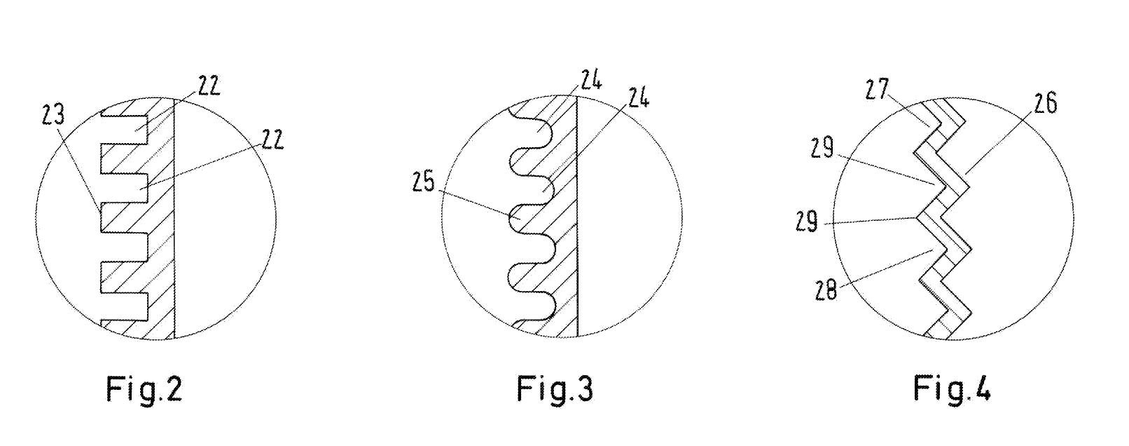

FIG. 2, FIG. 3, and FIG. 4 respectively show cross sections of a groove of the shielding element 1, according to exemplary embodiments of the present disclosure. FIG. 2 shows a structure with a rectangular cross section 22 of the grooves with a flat outer line 23. FIG. 3 shows a waved structure with a rounded inner structure 24 of the grooves, and a rounded edge 25 on top. FIG. 4 shows a sharp edged structure of the cross section of the grooves with a rectangular v-shaped structure 28, sharp edges 29 on top and sharp edged baselines 27 of the grooves.

In accordance with an exemplary embodiment, the back side of the shielding element is not flat, as in FIG. 2 or 3, but is shaped with a structure 26 in the same way as on top.

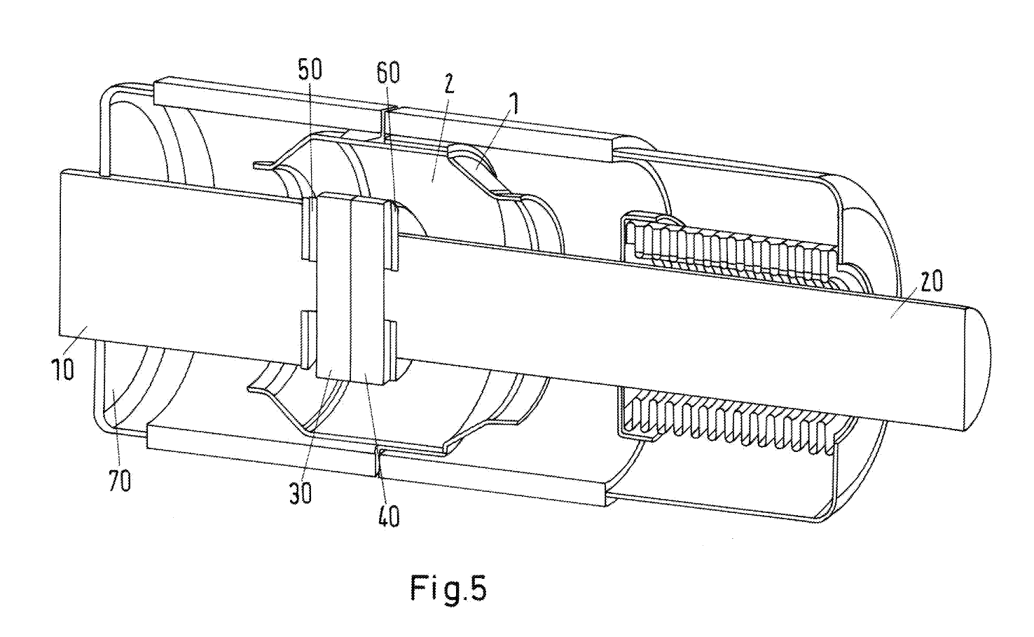

FIG. 5 shows a perspective view of the shielding element 1 arranged in a vacuum interrupter, wherein the region of the stems 10 and 20 near the contact pieces and/or the shielding plate 50, 60 and/or the backside of the contact pieces and/or the inner side of the end covers 70 can be structured at least partly, in order, to result in the same function of high absorbance of energy.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

### POSITION NUMBERS

1 shielding element
2 topographic structure
3 dimples
10 stem
20 stem
22 rectangular cross section
23 flat outer line
24 rounded inner structures
25 round edge on top
26 structure
27 sharp edged baselines
28 rectangular V-shaped structure
29 sharp edges on top
30 contact piece
40 contact piece
50 shielding plate
60 shielding plate
70 end cover

What is claimed is:

1. A shielding element for a medium voltage switchgear with at least one vacuum interrupter having at least two contacts, which are movable along a switching path between closed and open contact positions,
wherein the shielding element is positioned around a region of the contact position in the vacuum interrupter,
the shielding element comprising an inner surface having a topographic structure which is aligned parallel to the switching path of the contacts.

2. The shielding element according to claim 1, wherein the structure includes an alignment of parallel grooves.

3. The shielding element according to claim 2, wherein a cross section of the alignment of the grooves is a z-structure with sharp edges.

4. The shielding element according to claim 2, wherein a cross section of the alignment of the grooves is a wave-structure with round edges.

5. The shielding element according to claim 2, wherein a cross section of the alignment of the grooves is a u-structure with sharp edges.

6. The shielding element according to claim 1, wherein the shielding element is arranged in a sectionized shielding arrangement, and at least regions nearest to the contact positions are structured to include the topographic structure.

7. The shielding element according to claim 1, wherein each contact is mounted on a stem of the vacuum interrupter, and partial regions near the contact piece have structures applied with the topographic structure to absorb energy from light arc occurrence.

8. The shielding element according to claim 1, wherein at least one of (i) a backside of electrodes of the vacuum interrupter, a shielding plate of the vacuum interrupter, and an inner side of an end cover of the vacuum interrupter have structures applied with the topography structure to absorb the energy and vapour from arc.

9. A method for manufacturing a shielding element for a medium voltage switchgear with at least one vacuum interrupter having at least two contacts, the contacts being movable along a switching path between closed and open contact positions,
positioning the shielding element around a region of the contact position in the vacuum interrupter;
forming an inner surface of the shielding element to have a topographic structure which is aligned parallel to the switching path of the contacts;
forming the shielding element from at least one segment, which are manufactured as contoured cylindrical elements; and
applying the topographic structure by deep drawing in a direction along a cylinder-long-axis of the shielding element.
